(19) United States
(12) Patent Application Publication
(10) Pub. No.: US 2003/0053262 A1
(43) Pub. Date: Mar. 20, 2003

(54) Low-friction wear-resistant guide track for an actuator in a disk drive

(76) Inventors: Lawrence D. Clayton, Farmington, UT (US); Fred C. Thomas III, Ogden, UT (US); John C. Briggs, Lexington, MA (US); Jeffrey G. Villiard, Ogden, UT (US)

Correspondence Address: Robin S. Quartin, Woodcock Washburn Kurtz, Mackiewicz & Norris LLP, One Liberty Place - 46th Floor, Philadelphia, PA, 19103, US

(21) Appl. No.: 09/885,774

(22) Filed: Jun. 20, 2001

(51) Int. Cl. G11B 5/55

(52) U.S. Cl. 360/266.6

(57) ABSTRACT

This invention provides a disk drive having an actuator for engaging and disengaging read/write heads with a recording medium, where the actuator comprises a head stack assembly, on which the heads are mounted, a guide track on which the head stack assembly slides, and a diamond-like carbon (DLC) coating on at least a portion of the guide track, wherein reduced actuator friction and increased wear resistance is achieved. The invention also provides an actuator, for mounting in a disk drive and for communicating with a recording medium, a head stack assembly having read/write heads thereon, a corrosion resistant, heat dissipating guide track on which the head stack assembly slides, and a DLC coating on at least a portion of the guide track, for reducing actuator friction and wear and wherein corrosion resistance and heat dissipation is achieved.

### FIELD OF THE INVENTION

This invention relates to an actuator for carrying read/write heads into engagement with a recording medium and more particularly, to reduced friction and improved wear resistance, track-following, and seek performance with the application of an amorphous diamond-like carbon thin film coating to the guide track for the actuator.

### BACKGROUND OF THE INVENTION

Disk drives for storing electronic information are found in a wide variety of computer systems, including workstations, personal computers, and laptop and notebook computers. Such disk drives can be stand-alone units that are connected to a computer system by cable, or they can be internal units that occupy a slot, or bay, in the computer system.

Disk drives of the type that accept removable disk cartridges have become increasingly popular. One disk drive product that has been very successful is the ZIP™ 1″ drive designed and manufactured by Iomega Corporation, the assignee of the present invention. ZIP™ 1″ drives accept removable disk cartridges that contain a flexible magnetic storage medium upon which information can be written and read. The disk-shaped storage medium is mounted on a hub that rotates freely within the cartridge. A spindle motor within the ZIP™ 1″ drive engages the cartridge hub when the cartridge is inserted into the drive, in order to rotate the storage medium at relatively high speeds. A shutter on the front edge of the cartridge is moved to the side during insertion into the drive, thereby exposing an opening through which the read/write heads of the drive move to access the recording surfaces of the rotating storage medium. The shutter covers the head access opening when the cartridge is outside of the drive, to prevent dust and other contaminants from entering the cartridge and settling on the recording surfaces of the storage medium.

Two bearings in the linear actuator for a disk drive support a head stack assembly (HSA) on a guide track for positioning of the heads on the media. A down-track force generated on the heads by media rotation is reacted to at the bearings and transmitted to the guide track. The weight of the HSA combines with the down-track force to generate bearing reaction forces normal to the guide track which vary with drive orientation. Friction forces arising from the bearing reactions resist motion of the HSA along the guide track. The magnitude of the friction forces resisting HSA motion depends in part upon the coefficient of friction between the bearings and the guide track. A liquid lubricant is applied to the guide track and bearings to reduce the coefficient of friction and improve wear resistance.

While the liquid lubricant reduces friction and improves wear resistance, its use has several negative consequences for the drive. Inconsistent, insufficient, or uneven lubricant application can produce seek and track following errors. Particles or fibers trapped by the lubricant on the guide track can produce seek and track following errors. Excessive lubricant can migrate away from the guide track contaminating the heads and media. Excessive lubricant may be absorbed by the poron crash stop, used in ZIP™ 1″ drives, filling its pores, altering its energy absorbing characteristics, and generating suction forces between the crash stop and the head stack. Of 245 ZIP™ 1″ drives tested in a 16 week life test, 32 (13%) failed. Failure analysis attributed 25 (10%) of the failures to lube related problems, primarily absorption/depletion of the lube.

Lubrication problems are even more severe for notebook drives. Failures of notebook drives arising from depletion, migration, and breakdown of Floil 946P (olefinic synthetic oil) used to lubricate bearing to guide track contact points have occurred during life tests, engineering verification testing (EVT), and ongoing reliability testing (ORT) in significant numbers. Premature termination of life tests for 120 each of Model A and Model B 0.5″ notebook drives (“Model A” and “Model B”, respectively) has been attributed to breakdown of the liquid lube under high pressures and temperatures generated by friction at the guide track/bearing interfaces. Seven weeks into life testing 63 (52.5%) Model A and 29 (24.2%) Model B notebook drives had failed due to lube degradation, which resulted in increased friction and wear, generating seek and track following errors. These failures continued during life testing of a Model C 0.5″ notebook drive (“Model C”) and EVT testing of a Model D 0.5″ notebook drive (“Model D”). The first Model C life test was terminated after 4 weeks with 21 of 120 (17.5%) of the drives failing for lube breakdown. Actuators from 67 of 89 Model D drives in the EVT environmental bit error rate (bER) test were visually inspected for lube problems (discoloration, guide track wear, lube migration, etc.). All of the drives exhibited one or more of the lube problems inspected for, with the most common being migration away from the sliding surfaces followed by wear marks on the guide track. A large percentage of the drives also exhibited lube discoloration (brownish black slurry) on the guide track and/or bearings.

The use of liquid lubricants has proven less than satisfactory, and there is a need in the art to provide an alternative to the liquid lubricant used in drives. There is a need for an improved method to reduce friction and improve wear resistance of the actuator in disk drives, to improve track and seek performance, and to extend drive life and improve drive reliability. The present invention is directed to addressing these, and other needs.

### SUMMARY OF THE INVENTION

This invention provides a disk drive having an actuator for engaging and disengaging read/write heads with a recording medium, where the actuator comprises a head stack assembly, on which the heads are mounted, a guide track on which the head stack assembly slides, and a diamond-like carbon coating on at least a portion of the guide track, wherein reduced actuator friction and increased wear resistance is achieved.

This invention also provides a disk drive having an actuator for engaging and disengaging read/write heads with a recording medium, where the actuator comprises a head stack assembly, on which the heads are mounted, a corrosion resistant, heat dissipating guide track, on which the head stack assembly slides, and a diamond-like carbon coating on at least a portion of the guide track, wherein corrosion resistance and heat dissipation is achieved.

The invention also provides an actuator, for mounting in a disk drive and for communicating with a recording medium, comprising a head stack assembly having read/write heads thereon, a guide track on which the head stack assembly slides, and a diamond-like carbon coating on at least a portion of the guide track, for reducing actuator friction and wear.

The invention also provides an actuator, for mounting in a disk drive and for communicating with a recording medium, comprising a head stack assembly having read/write heads thereon, a corrosion resistant, heat dissipating guide track, on which the head stack assembly slides, and a diamond-like carbon coating on at least a portion of the guide track, wherein corrosion resistance and heat dissipation is achieved.

For a more detailed disclosure of the invention and for further objects and advantages thereof, reference is to be had to the following description taken in conjunction with the accompanying drawings.

### BRIEF DESCRIPTION OF THE DRAWINGS

FIG. 1 is a perspective view of an exemplary disk drive in which the present invention is employed.

FIG. 2 is a diagrammatic view of a flexible suspension for mounting a head stack assembly in a disk drive.

FIG. 3 is a perspective view, on enlarged scale, of the flexible suspension for mounting the head stack assembly of FIG. 1 as diagrammatically shown in FIG. 2.

FIG. 4 is a free body diagram of the forces generating actuator friction.

FIG. 5 is a graph showing the comparison of actuator friction for ZIP™ 1″ drives, and Model B and Model C 0.5″ notebook drives lubricated with Floil or DLC.

FIG. 6 is a graph showing the comparison of off-track error for ZIP™ 1″ drives lubricated with Floil or with DLC.

FIG. 7 is a graph showing the comparison of the change in average actuator friction for Model B 0.5″ notebook drives lubricated with Floil (diamonds) or DLC (squares) during a life test.

FIG. 8 is a graph showing the friction standard deviation for Model B 0.5″ notebook drives during the life test shown in FIG. 7.

FIG. 9 is a graph showing the comparison of the change in average actuator friction for Model C 0.5″ notebook drives lubricated with Floil (diamonds) or DLC (squares) during a life test.

FIG. 10 is a graph showing the friction standard deviation for Model C 0.5″ notebook drives during the life test shown in FIG. 9.

### DESCRIPTION OF THE PREFERRED EMBODIMENTS

It has been discovered that an amorphous diamond-like carbon (DLC) thin film coating, when applied to the guide track in a disk drive having an actuator, significantly reduces friction at the guide track/bearing interfaces. In addition to reducing friction, the hard carbon overcoat significantly increases wear resistance of the actuator, extending drive life and improving drive reliability. Significantly improved track following and seek performance (i.e., less off-track error and shorter track access times) is also attributed to reduced actuator friction arising from the DLC coating. Reduced friction and improved wear resistance, track-following, and seek performance are achieved with DLC coating when used in place of liquid lubricants. Diamond-like carbon coating may also be used in combination with liquid lubricants to achieve further performance improvements or when media or actuator design changes result in higher actuator friction.

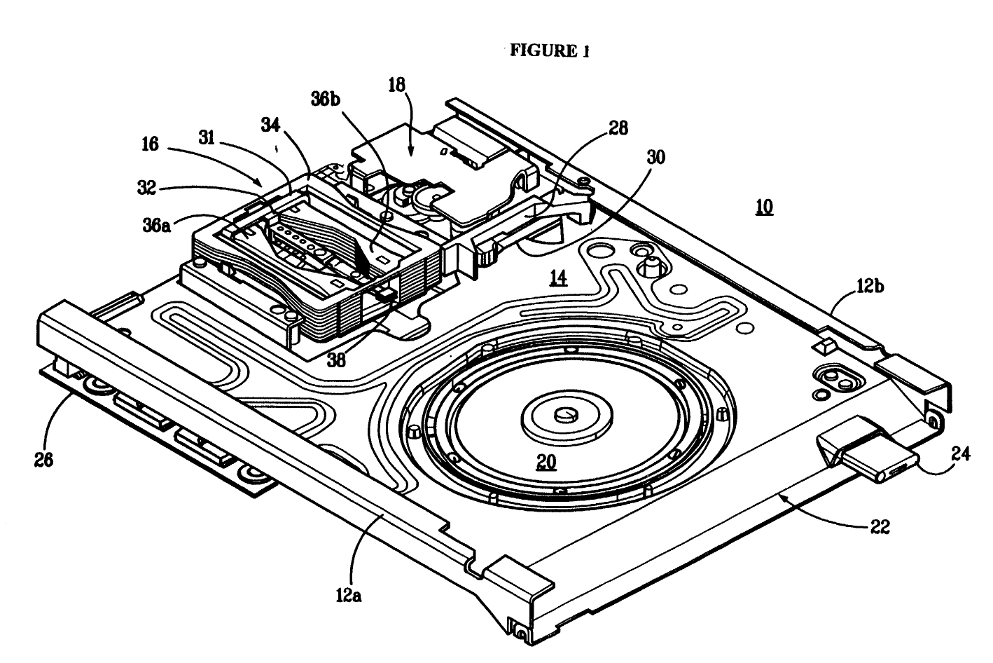

FIG. 1 shows an exemplary disk drive 10 in which the present invention may be employed. The disk drive 10 comprises a chassis 14 having unshaped outer edges that form opposed guide rails 12a, 12b that guide a removable disk cartridge (not shown) into the disk drive through opening 22. In the present embodiment, the chassis is metallic. A thin metal top cover (not shown) of the disk drive 10 has been removed so that the internal components of the drive are visible.

A cartridge shutter lever 28 and an eject lever 30 are rotatably mounted on the chassis. Both levers 28 and 30 are shown in FIG. 1 in the positions that they occupy when a disk cartridge is fully inserted into the drive. During cartridge insertion, the shutter lever swings from a forward position to the position shown in FIG. 1. During this movement, an abutment surface on the shutter lever 28 engages a shutter of the disk cartridge and moves the shutter to the side, exposing a head access opening in the front peripheral edge of the cartridge. The eject lever also moves from a forward position to the position shown in FIG. 1, when the cartridge is inserted. In the position shown in FIG. 1, the eject lever is in a cocked position, under spring tension. When it is desired to eject the disk cartridge from the drive 10, an eject button 24 is pushed. Among other things, this causes the eject lever 30 to be released from its cocked position, so that it springs forward to force the disk cartridge backwardly out of the disk drive.

The disk drive 10 also has a linear actuator 16 disposed at the rear of the chassis 14. The linear actuator 16 comprises a voice coil motor including a coil 31 mounted on a head stack assembly 32, an outer magnet return path assembly 34, and two inner return paths 36a, 36b on opposite sides of the head stack assembly 32. After a disk cartridge is inserted into the disk drive 10, the head stack assembly 32 carries a pair of read/write heads 38 over the recording surfaces of a disk-shaped storage medium within the cartridge. A spindle motor 20 is provided on the floor of the chassis 14. During cartridge insertion, the spindle motor 20 is translated vertically into engagement with a hub of the disk cartridge, in order to rotate the disk-shaped storage medium at a relatively high speed. A circuit board 26 is attached to the chassis 14 via a plurality of standoffs (not shown). The circuit board 26 carries the drive circuitry. A gear train mechanism 18 controls movement of the eject lever 30 and movement of a head retract mechanism (not shown) that moves the head stack assembly 32 to a parked position to prevent damage to the read/write heads 38, when the disk drive is not in use.

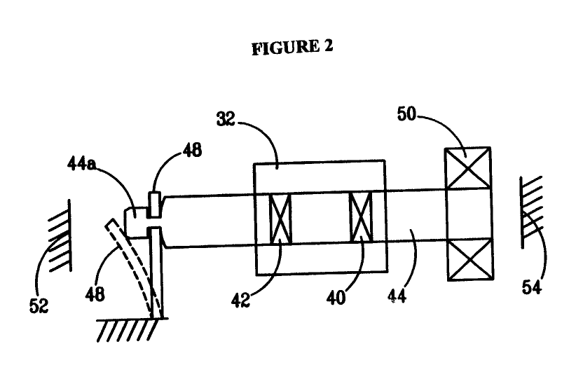

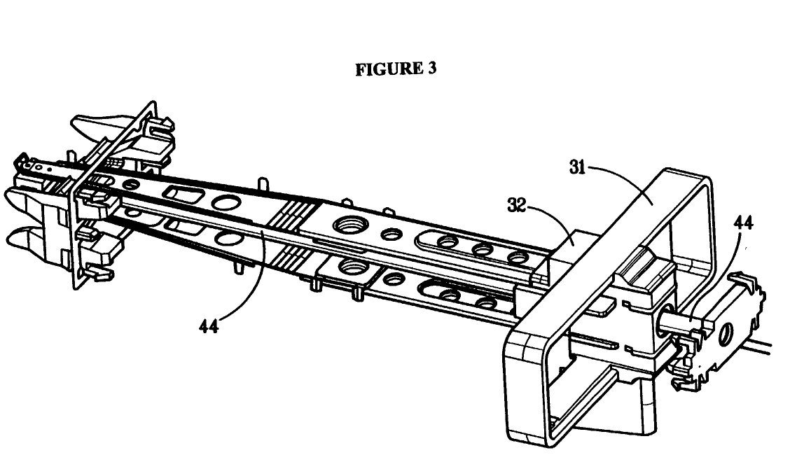

FIG. 2 shows the detail of the head stack assembly 32 mounted on spaced bearings 40 and 42, which in turn are mounted on a guide track 44, on which the head stack assembly 32 slides linearly. As shown in FIG. 2, the guide track 44 is centrally located, but may be positioned in other than a central location. By way of non-limiting example, the guide track 44 may be in the form of a round polished stainless steel rod, and is best seen in FIGS. 2 and 3. The bearings 40 and 42 have a low coefficient of friction and preferably are zirconia bearings.

Actuator friction forces which resist the motion of the head stack assembly (HSA) 32, and consequently the entire head stack assembly, along the guide track 44 come from two primary sources, (1) friction at the interface between the read/write heads 38 and the disk recording medium (head disk interface or HDI), and (2) friction between the actuator bearings 40 and 42 and the guide track 44.

The following expressions were derived for the friction force acting between the bearings and the guide track F_{BEARING} arising from media drag F_{MEDIA} on the heads

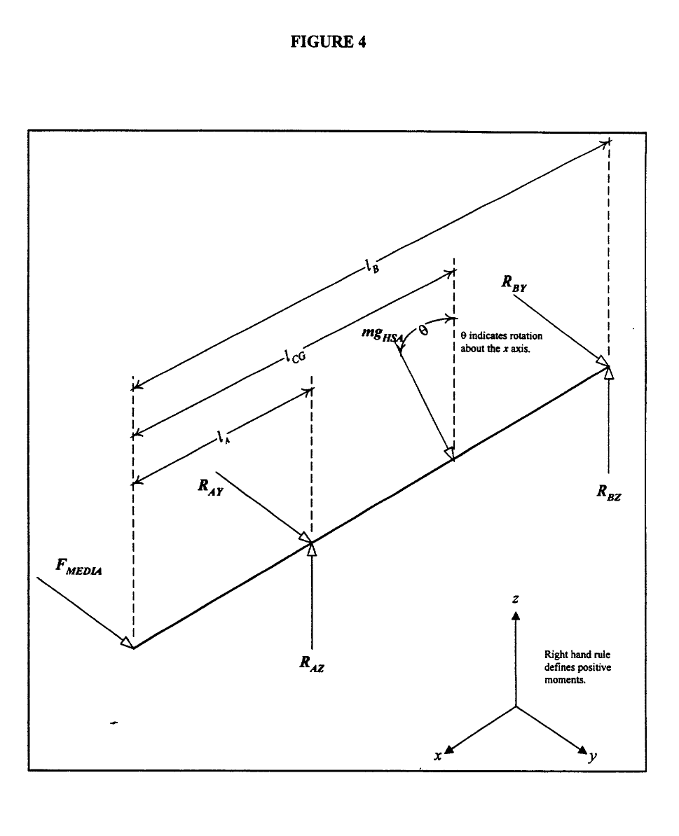

F_{BEARING}=μ(R_{A}+R_{B}) (1)

where μ is the coefficient of friction between the bearings and the guide track and R_{A} and R_{B} are reaction forces at the front and rear bearings located l_{A} and l_{B} from the heads along the drive X-axis (see FIG. 4). Bearing reaction forces arise from the media drag combined with the weight of the HSA mg_{HSA} located l_{cg} from the heads along the X-axis. Components of the bearing reaction force along the Y- and Z-axes vary with drive rotation θ about the X-axis as follows

$$\begin{matrix}{R}_{Ay} = \frac{( {l}_{cg} - {l}_{B} ) {mg}_{HSA} sin θ - {l}_{B} {F}_{MEDIA}}{( {l}_{B} - {l}_{A} )} & \text{(2a)} \\ {R}_{Az} = \frac{( {l}_{cg} - {l}_{B} ) {mg}_{HSA} cos θ}{( {l}_{B} - {l}_{A} )} & \text{(2b)} \\ {R}_{By} = \frac{( {l}_{A} - {l}_{cg} ) {mg}_{HSA} sin θ + {l}_{A} {F}_{MEDIA}}{( {l}_{B} - {l}_{A} )} & \text{(2c)} \\ {R}_{Bz} = \frac{( {l}_{A} - {l}_{cg} ) {mg}_{HSA} cos θ}{( {l}_{B} - {l}_{A} )} & \text{(2d)}\end{matrix}$$

Reaction forces at the front and rear bearings used to calculate the friction force in Equation 1 are vectorial sums of the reaction components in Equation 2

R_{A}=\sqrt{R_{Ay}²+R_{Az}²} (3a)

R_{B}=\sqrt{R_{By}²+R_{Bz}²} (3b)

A statistical expression for the head drag arising from 100 MByte media derived using regression analysis predicts 83.2% (Rₐ²=0.832) of the variation in media drag with radial head position r and gram load G

F_{MEDIA}=2.292−0.978r+0.104r²+0.025G²+ε (4)

where ε is a 16.8% uncertainty term with a mean of 0 and standard deviation of 0.126. A similar empirical expression may be derived for head drag arising from 250 MByte media. All of the physical parameters required to calculate the bearing friction force using Equations 1 through 4 are readily determined with the exception of the coefficient of friction μ between the guide track and bearings.

The coefficient of friction between the guide track and the bearings is defined as the ratio of tangential force to normal load during a sliding process (Equation 1). The coefficient of friction depends primarily upon the minimum shear flow stress τₛ and the minimum hardness H of the two surfaces in contact

$$μ ∝ \frac{{τ}_{s}}{H} . \qquad ( 5 )$$

Surface wear arises from friction between two sliding surfaces. The volume of wear per unit sliding distance ΔV/Δl or wear rate for two surfaces in sliding contact depends upon the normal contact force Pₙ and the minimum hardness of the two surfaces

$$\frac{Δ V}{Δ l} ∝ \frac{{P}_{n}}{H} \qquad ( 6 )$$

Like friction, wear is inversely proportional to the minimum hardness of the two surfaces in contact.

Friction between the linear actuator guide track 44 and the bearings 40 and 42 is reduced and wear resistance is enhanced by the application of a thin diamond-like carbon (DLC) film to at least a portion of the guide track. In some embodiments of the invention, the guide track may be entirely coated with a DLC film. In other embodiments it is desired to coat only a portion of the guide track. In preferred embodiments, the DLC film is applied to at least the portion of the guide track over which the HSA slides.

Diamond-like carbon coatings are an amorphous form of hydrogenated carbon with many useful physical properties including low friction, high hardness and wear resistance, corrosion resistance, high thermal conductivity, high electrical resistance, and optical properties similar to diamond (Grill & Meyerson, “Development and Status of Diamondlike Carbon” in K. E. Spear & J. P. Dismukes (eds.), Synthetic Diamond: Emerging CVD Science and Technology, John Wiley & Sons, New York, N.Y., 1994, chp. 5, p. 91; Grill, “Tribology of Diamond-Like Carbon and Related Materials: An Updated Review,” Surf Coat. Technol., 1997, 94/95:507-513; Grill, “Diamond-Like Carbon: State of the Art,” Diam. Rel. Mater., 1999, 8:428-434; Bentzon et al., “Metallic Interlayers Between Steel and Diamond-Like Carbon,” Surf. Coat. Technol., 1994, 68/69:651-655; Yoshino et al., “Deposition of A Diamond-Like Carbon Film on A Stainless Steel Substrate: Studies of Intermediate Layers,” Surf Coat. Technol., 1991, 47:84-88, each of which is incorporated herein in its entirety by reference). Diamond-like carbon films are amorphous materials that contain a mixture of carbon atoms bonded mostly in sp³ (tetrahedral diamond) and sp² (trigonal graphite) hybridizations. Physical properties of DLC films depend upon the ratio of sp³ to sp² bonded carbon. Hydrogenated DLC coatings are most frequently used in applications that require the low coefficients of friction and high wear-resistance of these materials.

The application of a DLC coating to the guide track results in (1) reduced actuator friction, (2) increased reliability and wear resistance, (3) reduced off-track error, and (4) increased seek rates and shorter seek times.

The chemically inert DLC coating renders a DLC-coated guide track corrosion resistant. Additionally, because of the high thermal conductivity of a DLC coating, application of a DLC coating to the guide track, provides enhanced dissipation of heat by the guide track from bearing contact points.

Numerous techniques are known to the art for the deposition of DLC coatings (see Grill & Meyerson, supra; Grill, 1999, supra; Yoshino et al., supra). All deposition techniques require either a gaseous hydrocarbon or solid carbon or graphite target as a growth precursor. Deposition is a nonequilibrium process in which film growth arises from bombardment of a surface by energetic ions. Energetic ions are generated by either ion beam sputtering of a carbon target (physical vapor deposition) or from a plasma of the gaseous hydrocarbon precursor (plasma-assisted chemical vapor deposition). Depositions of DLC coatings are performed in hydrogen rich environments to obtain films which contain roughly 20-60% hydrogen. Hydrogen is required to produce the diamond-like properties of the film. Total hydrogen content determines film structure (i.e., ratio of sp³ to sp² bonded carbon) and therefore controls the physical properties of the film including hardness, density, and internal stress as well as electrical and optical properties.

Tribological DLC coatings, including those tested on ZIP™ 1″ drive actuator guide tracks, are typically deposited using plasma assisted chemical vapor deposition in a parallel plate RF reactor system (RF PACVD) (see Grill & Meyerson, supra; Grill, 1997, supra; Grill, 1999, supra). Parallel plate reactors are typically used to generate uniform films over large areas with simple planar or rotational symmetry. Plasma assisted chemical vapor deposition of DLC is achieved with a negatively biased substrate to accelerate energetic ions from the plasma towards the film growing on the substrate surface. Numerous gaseous hydrocarbons have been used as growth precursors for DLC coatings. Properties of DLC films, which are largely independent of the hydrocarbon precursor used, depend strongly upon the energy of the impacting ions. The energy of the impacting ions is controlled by the deposition parameters. Deposition parameters for RF PACVD include the RF power, pressure in the reactor, substrate temperature, and the negative bias of the substrate. DLC coatings are deposited at substrate temperatures ranging from room temperature to 250° C. At substrate temperatures above 250° C. the ratio of sp³ to sp² bonded carbon decreases rapidly with the formation of stable graphitic carbon. Low deposition temperatures make DLC coatings suitable for a wide range of substrate materials and applications. Substrate bias has the dominant effect on the properties of DLC coatings. Impact energy of the ions bombarding the growing film is directly proportional to the substrate bias and inversely proportional to reactor pressure. In general low reactor pressure and high substrate bias are required to obtain hard wear resistant films. Substrate bias and ion impact energy may be varied by adjusting the RF power of the reactor independent of deposition pressure to achieve the desired film properties.

A disadvantage of DLC coatings is high internal stresses generated during film growth. High internal stresses weaken film adhesion to the substrate. Poorly adhered DLC films will fail to protect substrate surfaces and reduce friction during sliding contact. Intrinsic film stresses may vary with hydrogen content (i.e., ratio of sp³ to sp² bonded carbon), surface preparation, and deposition parameters used for a particular deposition technique. In order to improve wear resistance and avoid delamination, adhesion forces for DLC coatings must exceed internal stresses. Several techniques are known to those of skill in the art that may be used to improve film adhesion or reduce internal stresses (see Grill & Meyerson, supra; Bentzon et al., supra; Yoshino et al., supra). The particular technique to use to improve film adhesion will depend upon the particular substrate material and deposition technique used, but will be routinely selected by those of skill in the art. DLC coatings adhere well to silicon, quartz, and substrates which form carbides, including iron alloys and titanium. DLC coatings do not typically adhere well to stainless steel substrates like the 440C actuator guide track. One technique used to improve adhesion of DLC coatings to stainless steel is the formation of intermediate layers between the steel and the DLC coating (see Bentzon et al., supra; Yoshino et al., supra). Metallic interlayers which improve DLC coating adhesion are capable of forming hard carbides, and may comprise one or more elements including, but not limited to, Ti, Cr, Mo, Si, and Cu. Single or multiple intermediate layer structures may be used, and the DLC coating may be doped with elements such as, but not limited to, Si, N, or carbide forming metals, to reduce internal stresses while maintaining desirable film characteristics, including low friction.

Unlike liquid lubricants which achieve reduced friction and wear through partial or complete separation of two surfaces by a liquid layer, DLC coatings reduce friction and wear, in part, by increasing surface hardness. In addition to increased hardness, wear and friction are reduced during sliding friction by a transformation at the surface of the DLC film to an interfacial transfer layer (see Grill & Meyerson, supra; Grill, 1997, supra). The shear stress of the transfer layer is low resulting in a low coefficient of friction (Equation 5). Low friction and wear for DLC coatings is the result of the low shear strength of the transfer layer and high hardness of the surface.

While FIG. 2 is a diagram of a flexured mounting system, it will be understood by those skilled in the art, that the application of DLC coatings to the guide track can be used for friction reduction with non-flexured as well as flexured mounting systems in disk drives having linear actuators. The present invention is applicable to disk drives such as disclosed in U.S. Pat. No. 5,920,445, which is incorporated herein by reference. Those of skill in the art will recognize that the present invention is applicable to reduce friction and increase wear resistance in any magnetic and optical drives having linear actuators, for example, wherein a head stack assembly slides along a guide track.

Other embodiments of the invention will be readily understood by those of skill in the art.

The invention is further illustrated by way of the following examples, which are intended to elaborate several embodiments of the invention. These examples are not intended, nor are they to be construed, as limiting the scope of the invention. It will be clear that the invention may be practiced otherwise than as particularly described herein. Numerous modifications and variations of the present invention are possible in view of the teachings herein and, therefore, are within the scope of the invention.

### EXAMPLES

### Example 1

### Measuring Actuator Friction

Positional control of the HSA is achieved through variations in the current input to the HSA coil. Electrical current, proportional to the servo digital analog conversion (DAC) count, is converted to a physical force acting on the HSA by the voice coil motor (VCM) fixed magnetic field. Total actuator friction is measured using a program which allows a host PC to acquire and record the magnitude of the servo DAC to a file as the actuator sweeps over a range of tracks. During constant velocity sweeps of the heads inbound (OD to ID) and outbound (ID to OD) the PC queries the drive for its track position and the corresponding value of the DAC register. The PC stores this data in hexadecimal format to a file. A second program parses the DAC data and converts it to ASCII text format, subdividing the full inbound and outbound range of tracks into smaller track bins for which average inbound and outbound DAC counts are calculated along with a difference between the inbound and outbound DAC count for each bin. The conversion program computes DAC measurement averages for the full range of tracks which are displayed and stored to the ASCII text file. Friction force resisting motion of the HSA is directly proportional to the difference between the inbound and outbound DAC counts (i.e., ΔDAC) divided by 2.

Servo DAC measurements may also be used to obtain a conversion factor relating DAC count to actuator force. The difference between the inbound DAC (or outbound DAC) with the drive oriented nose up and the inbound DAC (or outbound DAC) with the drive oriented nose down is equivalent to twice the weight of the HSA. Servo DAC may be converted to an equivalent actuator friction force F_{LOSS} using the following conversion factor for the inbound measurement

$${K}_{ACT} = \frac{2 {mg}_{HSA}}{( {DAC}_{IN , UP} - {DAC}_{IN , DOWN} )} \qquad ( 7 )$$

which is equivalent to

$${K}_{ACT} = \frac{2 {mg}_{HSA}}{( {DAC}_{OUT , UP} - {DAC}_{OUT , DOWN} )} \qquad ( 8 )$$

for the outbound measurement.

### Example 2

### Comparison of Actuator Friction Forces Under Floil and DLC Conditions

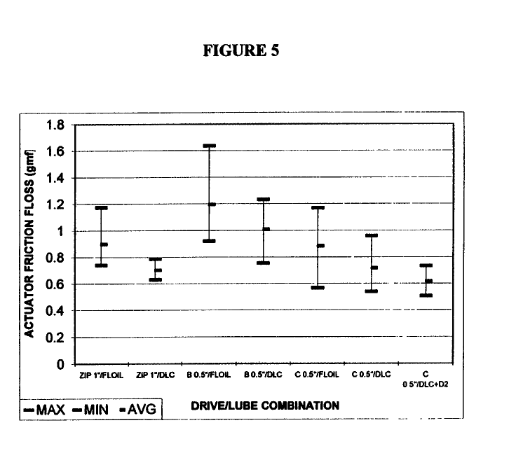

Comparative measurements of actuator friction force (F_{LOSS}) for ZIP™ 1″ and for 0.5″ notebook drives with standard Floil lube and DLC coated guide tracks were performed. Servo ΔDAC measurements obtained for the drives tested flat were converted to equivalent friction loss forces F_{LOSS} using the conversion factors from Equations 7 and 8. FIG. 5 depicts average actuator friction force and friction force range for three drives tested. Tested were 10 ZIP™ 1″ 100 MByte drives with Floil lube and 16 of the same drive with DLC coated guide tracks and no liquid lube. Twenty Model B 100 MByte notebook drives with Floil lube were tested along with 14 of the same drive with DLC coated guide tracks and no liquid lube. Fifty-four Model C 250 MByte notebook drives with standard Floil lube were tested along with 50 Model C drives with DLC coated guide tracks and no lube and 21 Model C drives with DLC coated guide tracks and Microgliss D2 liquid lubricant. Results of ANOVA analysis comparing F_{LOSS} variations for each of the drives tested with DLC coated guide tracks to the standard Floil lubed drives, are presented in Table 1.

TABLE 1
One-way Analysis of Variance DLC Comparison for ZIP (1″) 100 MByte Drive

| Source | DF | SS | MS | F | P |
|---|---|---|---|---|---|
| Factor | 1 | 0.2396 | 0.2396 | 20.92 | 0.000 |
| Error | 24 | 0.2749 | 0.0115 | | |
| Total | 25 | 0.5145 | | | |

Individual 95% CIs For Mean

| | | | | |
|---|---|---|---|---|
| Level | N | Mean | StDev | ------+---------+---------+---------+ |
| ZIP/DLC | 16 | 0.7027 | 0.0513 | (----*-----) |
| ZIP/FLOIL | 10 | 0.9000 | 0.1618 | (------*------) |
| | | | | ------+---------+---------+---------+ |
| Pooled StDev = | | 0.1070 | | 0.70 0.80 0.90 1.00 |

One-way Analysis of Variance DLC Comparison for Model B (0.5″) 100 MByte Drive

| | | | | | |
|---|---|---|---|---|---|
| Source | DF | SS | MS | F | P |
| Factor | 1 | 0.2821 | 0.2821 | 12.13 | 0.001 |
| Error | 32 | 0.7445 | 0.0233 | | |
| Total | 33 | 1.0266 | | | |

Individual 95% CIs For Mean

| | | | | |
|---|---|---|---|---|
| Level | N | Mean | StDev | --------+---------+---------+------ |
| Model B/DLC | 14 | 1.0104 | 0.1189 | (-------*-------) |
| Model B/FLOIL | 20 | 1.1955 | 0.1718 | (------*-----) |
| | | | | --------+---------+---------+------ |
| Pooled StDev = | | 0.1525 | | 1.00 1.10 1.20 |

One-way Analysis of Variance DLC Comparison for Model C (0.5″) 250 MByte Drive

| | | | | | |
|---|---|---|---|---|---|
| Source | DF | SS | MS | F | P |
| Factor | 2 | 1.32108 | 0.66054 | 73.18 | 0.000 |
| Error | 122 | 1.10115 | 0.00903 | | |
| Total | 124 | 2.42223 | | | |

Individual 95% CIs For Mean

| | | | | |
|---|---|---|---|---|
| Level | N | Mean | StDev | ---+---------+---------+---------+--- |
| Model C/DLC | 50 | 0.71656 | 0.07165 | (--*-) |
| Model C/DLC + D2 | 21 | 0.61993 | 0.06081 | (---*---) |
| Model C/FLOIL | 54 | 0.88437 | 0.12098 | (-*--) |
| | | | | ---+---------+---------+---------+--- |
| Pooled StDev = | | 0.09500 | | 0.60 0.70 0.80 0.90 |

ANOVA analysis indicates reductions in actuator friction F_{LOSS} are statistically significant for each of the drives tested when the guide track is coated with DLC. Actuator friction for the ZIP™ 1″ 100 MByte drives is reduced by 22% on average and friction variability (StDev) is reduced by a factor of 3 when DLC coating (no liquid lube) is used in place of Floil to lubricate the guide track. Actuator friction for the Model B 100 MByte drives is reduced 15.5% and friction variability is reduced 31% when DLC coating (no liquid lube) replaces Floil. Actuator friction for the Model C 250 MByte drives is reduced 19% when DLC coating replaces Floil and 30% when DLC is used in combination with Microgliss D2. Friction variability is also significantly reduced for Model C by 41% for the DLC coating alone and by a factor of 2 when DLC is combined with Microgliss D2.

### Example 3

### Comparison of off Track Error Under Floil and DLC Conditions

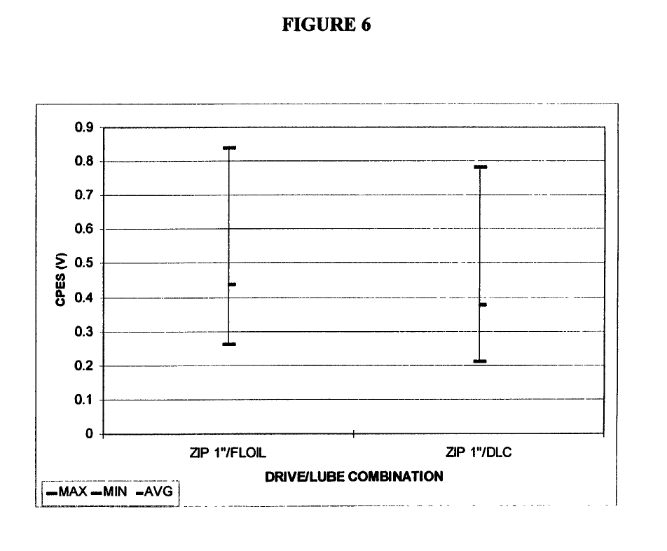

Track following and seek performance improves when actuator friction is reduced. Track following performance is characterized by the composite position error signal (CPES). Less off track error is associated with lower CPES values. FIG. 6 depicts the reduction in off track error (CPES) for 16 ZIP™ 1″ 100 MByte drives with DLC coated guide tracks and no liquid lube compared to 15 of the same drive lubricated with Floil. Results of an ANOVA analysis comparing CPES for both sets of drives, presented in Table 2, confirm that the reduction in CPES for the DLC coating is statistically significant.

TABLE 2
One-way Analysis of Variance CPES Comparison for ZIP (1″) 100 MByte Drive

Analysis of Variance

| Source | DF | SS | MS | F | P |
|---|---|---|---|---|---|
| Factor | 1 | 0.59699 | 0.59699 | 81.09 | 0.000 |
| Error | 643 | 4.73402 | 0.00736 | | |
| Total | 644 | 5.33100 | | | |

Individual 95% CIs For Mean
Based on Pooled StDev

| | | | | |
|---|---|---|---|---|
| Level | N | Mean | StDev | ----+----------+----------+----------+-- |
| ZIP/FLOIL | 315 | 0.43709 | 0.09473 | (---*---) |
| ZIP/DLC | 330 | 0.37623 | 0.07632 | (--*---) |
| | | | | ----+----------+----------+----------+-- |
| Pooled StDev = | | 0.08580 | | 0.375 0.400 0.425 0.450 |

The rate at which the actuator seeks over a given distance to a track and the seek time are also adversely affected by actuator friction. Seek acceleration a_{SK} depends upon HSA mass m_{HSA} and flux density B of the VCM magnets in the gap at the HSA coil as follows

$${a}_{SK} = \frac{Bli - {F}_{LOSS}}{{m}_{HSA}} \qquad ( 9 )$$

where l is the active length of the VCM coil wire and i is the coil current. Seek or track access time is derived from seek acceleration as follows

$${t}_{SC} ∝ \sqrt{\frac{2 {m}_{HSA} x}{( Bli - {F}_{LOSS} )}} \qquad ( 10 )$$

where x is the distance traveled between tracks at an average seek rate of a_{SK}. Equations 9 and 10 show that seek acceleration decreases and seek time increases as actuator friction F_{LOSS} increases. To maximize seek rate and minimize access time the actuator friction should be minimized. Actuator friction is significantly reduced for Iomega ZIP™ 1″ and notebook 0.5″ drives by DLC coated guide tracks with no liquid lube or in combination with a liquid lube like Microgliss D2.

### Example 4

### Comparison of Life Tests of Model B Drives Under Floil and DLC Conditions

Life tests are performed to determine and insure the long-term reliability of Iomega drives. Each drive is subjected to roughly 17.5 hours of head on time each day along with 24 software ejects, 1 manual eject, 11 power cycles, and 9.06 GBytes written and read. Head on time for the life test includes 372,000 random read/writes per day. The life test script was modified to include a special command which performed a friction (ΔDAC) measurement each day prior to the standard life test operations. Life tests with friction measurements were performed for 10 Model B 100 MByte notebook drives with Floil lube and 12 Model B drives with DLC coated guide tracks (no liquid lubricant) for comparison. The number of available test slots limited the number of Model B drives tested. A life test during which friction measurements were tracked was also performed for Model C 250 MByte notebook drives. More test slots were available for this test and 56 Model C 250 MByte notebook drives with standard Floil lube were tested along with 20 Model C drives with DLC coated guide tracks combined with Microgliss D2 liquid lubricant.

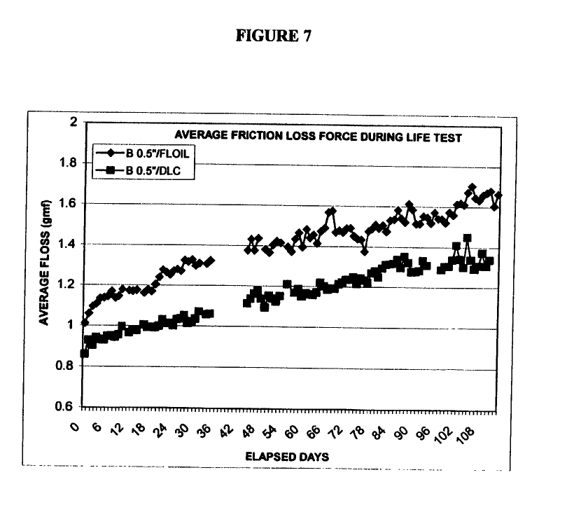

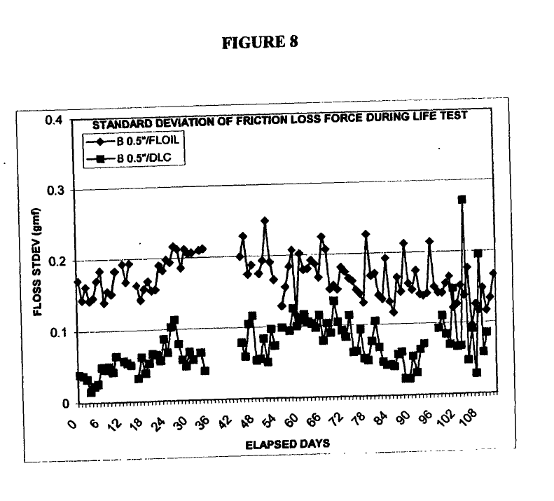

FIGS. 7 and 8 depict the shift in average actuator friction F_{LOSS} and friction standard deviation for the Model B drives during the life test. The Model B drives with DLC coated guide tracks generated significantly lower average actuator friction throughout the test than the drives lubricated with Floil. Variability (standard deviation) of the friction measurements for the Model B/DLC drives was also consistently lower throughout the test. The fewest failures (1 of 12 or 8.3%) occurred for the Model B/DLC drives which had a single WAQ (won't acquire) failure after 77 days in test. This type of failure is not typically associated with lubrication problems and could not be attributed to the DLC coating. Four of the Floil lubricated Model B drives failed during the life test with all 4 failures attributed to lube breakdown for a 40% failure rate. The first failure occurred 53 days into the life test with the second failure occurring at 91 days and the third and fourth failures occurring at roughly 100 days. Failures for the small sample of Model B/FLOIL drives started significantly later than the first life test for 120 Model B drives for which the first lube failures occurred at 21 days and continued until 29 failures attributed to lube breakdown had occurred after 49 days and the test was terminated.

### Example 5

### Comparison of Life Tests of Model C Drives Under Floil and DLC Conditions

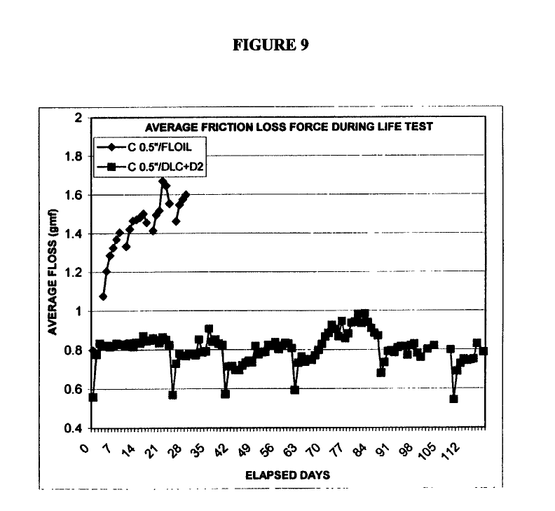

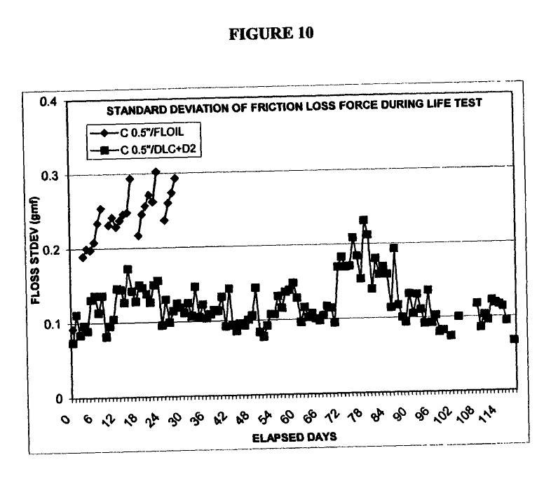

FIGS. 9 and 10 depict the shift in actuator friction average and standard deviation during the life test for the Model C drives. Initial average actuator friction for the Model C/FLOIL and Model C/DLC+D2 drives in FIG. 9 is lower than average friction for the corresponding Model B drives in FIG. 7. But actuator friction increases at a much higher rate during the first few days of testing for the Model C drives compared to the Model B drives. Eventually average F_{LOSS} stabilizes at less than 1 gmf for the Model C drives with DLC coated guide tracks and Microgliss D2 liquid lubricant. However, the average friction continued to increase sharply for the standard Model C/FLOIL drives roughly doubling during the first 27 days of the test. Increased friction resists HSA motion resulting in problems seeking to and staying on track. Consistent with this trend the Model C/FLOIL drives began to fail much earlier in the life test and more frequently than the Model B/FLOIL drives. The first Model C drive failure attributed to lube breakdown occurred after just 6 days in test and lube failures continued until 11 drives (19.6%) had failed for lube breakdown and the test was terminated after only 27 days. Nine of the failures attributed to lube breakdown were for excessive soft seek errors, one was a mis-compare and one was a write failure. Twenty of the Model C/FLOIL drives from the life test were inspected for lube problems. Only one of these drives had failed during the life test. All of the actuators in these drives exhibited lube discoloration and guide track wear consistent with lube degradation indicating more lube related failures were imminent had testing continued. Average actuator friction for the Model C drives with DLC coated guide tracks and Microgliss D2 lubricant follows a significantly different pattern in FIG. 9 during life test. After increasing significantly the first few days, average actuator friction stabilizes at 0.8 to 1.0 gmf and remains relatively constant until the 250 MByte cartridges are replaced after roughly 3 to 4 weeks. Each time the cartridges are replaced the actuator friction drops back to roughly the initial value and the pattern repeats until the cartridges are replaced again. Clearly the sharp increase in friction each time the 250 MByte cartridges are replaced is the result of increased head disk interface (HDI) friction which increases media drag on the heads F_{MEDIA}. Friction between the bearings and the DLC coated guide tracks with Microgliss D2 lubricant remains relatively unchanged throughout the life test as evidenced by the return to roughly the initial average actuator friction each time the worn 250 MByte media is replaced with new media. Lower actuator and bearing on track friction significantly delays failures of the Model C/DLC+D2 drives attributed to lube problems. The first failure occurred after 76 days in test and 5 additional failures occurred between 77 and 96 days in test. These failures were attributed to depletion of the Microgliss D2 lubricant suggesting that increased lubricant volume could have prolonged the life of these drives to equal that of the drives which survived the life test.

The foregoing examples are meant to illustrate the invention and are not to be construed to limit the invention in any way. While there have been described preferred and alternate embodiments of the invention, it will be understood that further modifications may be made without departing from the spirit and scope of the invention as set forth in the appended claims.

All references cited herein are incorporated herein in their entirety by reference.

What is claimed is:

1. A disk drive having an actuator for engaging and disengaging read/write heads with a recording medium, said actuator comprising:
a head stack assembly, said heads being mounted on said head stack assembly;
a guide track on which said head stack assembly slides; and
a diamond-like carbon (DLC) coating on at least a portion of said guide track, wherein reduced actuator friction is achieved.

2. The disk drive of claim 1, further comprising a lubricant on at least a portion of said guide track.

3. The disk drive of claim 1, wherein said guide track is a cylindrical rod.

4. The disk drive of claim 3, wherein the cylindrical rod is stainless steel.

5. The disk drive of claim 1, further comprising at least one metallic interlayer between the guide track and the DLC coating.

6. The disk drive of claim 5, wherein the metallic interlayer comprises one or more elements selected from the group consisting of Ti, Cr, Mo, Si, and Cu.

7. The disk drive of claim 1, wherein the DLC coating is doped with one or more elements selected from the group consisting of Si, N, and carbide forming metals.

8. A disk drive having a linear actuator for engaging and disengaging read/write heads with a recording medium, said linear actuator comprising:
a head stack assembly, said heads being mounted on said head stack assembly;
a central guide track on which said head stack assembly slides linearly; and
a DLC coating on at least a portion of said central guide track, wherein reduced actuator friction is achieved.

9. A disk drive having a linear actuator for engaging and disengaging read/write heads with a recording medium, said linear actuator comprising:
a head stack assembly, said heads being mounted on said head stack assembly;
a guide track on which said head stack assembly slides linearly; and
a DLC coating on at least a portion of said guide track, wherein reduced actuator friction is achieved.

10. The disk drive of claim 9, wherein the guide track is a stainless steel rod.

11. A disk drive having an actuator for carrying read/write heads into engagement with a recording medium, said actuator comprising:
a head stack assembly, said heads being mounted on said head stack assembly;
a corrosion resistant, heat dissipating guide track on which said head stack assembly slides; and
a DLC coating on at least a portion of said guide track, wherein corrosion resistance and heat dissipation is achieved.

12. A disk drive having an actuator for engaging and disengaging read/write heads with a recording medium, said actuator comprising:
a head stack assembly, said heads being mounted on said head stack assembly;
a guide track on which said head stack assembly slides; and
a DLC coating on at least a portion of said guide track, wherein increased wear resistance is achieved.

13. An actuator for mounting in a disk drive and for communicating with a recording medium, comprising:
a head stack assembly having read/write heads thereon;
a guide track whereon said head stack assembly slides; and
a diamond-like carbon coating on at least a portion of said guide track, for reducing actuator friction and wear.

14. An actuator for mounting in a disk drive and for communicating with a recording medium, comprising:
a head stack assembly having read/write heads thereon;
a corrosion resistant, heat dissipating guide track whereon said head stack assembly slides; and
a diamond-like carbon coating on at least a portion of said guide track, wherein corrosion resistance and heat dissipation is achieved.
